(19) United States
(12) Patent Application Publication
(10) Pub. No.: US 2026/0158461 A1
(43) Pub. Date: Jun. 11, 2026

(54) SYSTEM AND METHOD FOR PRODUCING GRAPHITE POWDER

(71) Applicants: MEI LIN Holdings Ltd., Kaohsiung City (TW); MEI LIN ENERGY TECHNOLOGY CO., LTD., Kaohsiung City (TW)

(72) Inventors: Min-Hang Weng, Kaohsiung City (TW); Ru-Yuan Yang, Kaohsiung City (TW); Wu-Yeh Lee, Kaohsiung City (TW); Pai-Yi Hsueh, Kaohsiung City (TW)

(73) Assignees: MEI LIN Holdings Ltd., Kaohsiung City (TW); MEI LIN ENERGY TECHNOLOGY CO., LTD., Kaohsiung City (TW)

(21) Appl. No.: 18/970,598

(22) Filed: Dec. 5, 2024

(51) Int. Cl. B01J 6/00; C01B 32/205; H05B 6/64

(52) U.S. Cl. CPC B01J 6/008; C01B 32/205; H05B 6/64

(57) ABSTRACT

The present disclosure provides a system for producing graphite powder. The system includes a feeding module, a microwave heating chamber, a heating tube, and a discharging module. A spiral stirring mechanism is provided within a heating tube disposed in the microwave heating chamber and is configured to push crushed objects from one end of the heating tube to the other end. The spiral stirring mechanism has a stirring shaft provided with a plurality of stirring blades. The present disclosure also provides a method for producing graphite powder. The system and method for producing graphite powder according to the present disclosure are capable of processing a large quantity of organic crushed objects, so that the organic crushed objects can be quickly heated and decomposed into graphite powder, which is then cooled and discharged quickly.

### FIELD

The present disclosure relates to a system and a method for producing powder, and more particularly to a system and a method for producing graphite powder with microwave heating technology.

### BACKGROUND

Graphite powder is soft, black-gray in color, has a greasy texture, and can be used in printing on paper. The Mohs hardness of the graphite powder is from 1 to 2, and the hardness can increase to a range from 3 to 5 along the vertical direction with the increase of impurities. The specific gravity of the graphite powder is 1.9 to 2.3. When isolated from oxygen, the melting point of the graphite powder is above 3000° C., making it one of the most heat-resistant minerals. At the room temperature, the graphite powder presents relatively stable chemical properties and is insoluble in water, dilute acids, dilute alkalis, and organic solvents. The graphite powder reacts with oxygen at different high temperatures to generate carbon dioxide or carbon monoxide. Among halogens, only fluorine can directly react with elemental carbon. Under a heating process, the graphite powder is more easily oxidized by acid. The graphite powder can also react with many metals at high temperatures to form metal carbides. In addition, the graphite powder can be used for metal smelting at high temperatures.

The traditional method for preparing the graphite powder includes the following steps:
1. The raw material micro-powder is conveyed, in a vacuum state, into a graphite crucible, which is then sealed with a binder.
2. The graphite crucible containing the raw material micro-powder is placed in a graphitization furnace, heated at a heating rate of 0.7° C. to 10° C. per minute, and undergoes thermal treatment at temperatures between 2000° C. and 3300° C. for 5 to 48 hours.
3. The graphite crucible is then cooled at a uniform rate for 4 to 15 days to room temperature, thus obtaining the graphite powder product.

However, the traditional heating method is too slow, and the process is energy-consuming. Microwaves are electromagnetic waves with frequencies ranging from 300 MHz and 300 GHz. In recent years, the microwaves have also been applied in various industrial and agricultural fields for heating, drying or pyrolyzing materials. The commonly used microwave power frequencies are 915 MHz and 2450 MHz, which can cause the molecules of polar substances to rub against each other to generate heat and warmth. In practice, the microwave power frequency can be selected based on the shape, size and moisture content of the heated material. Microwave heating is a process in which the heated object becomes a heating source without the need for heat conduction, and both the interior and exterior are heated at the same time, thus achieving the heating effect in a short time. In addition, during a microwave heating process, electromagnetic waves can typically penetrate all parts of the object evenly to generate heat, thus significantly improving the heating uniformity. In a microwave heating process, the microwave energy can only be absorbed by the heated object to generate heat while the air and corresponding container in the heating chamber do not heat up, resulting in extremely high thermal efficiency and a significant improvement in the production environment.

In the conventional microwave heating equipment, the objects could only be heated to about 1000 degrees Celsius after absorbing microwaves, which is unable to make the heated objects reach the temperatures required for graphitization. On the other hand, once the objects reach the high pyrolysis temperature and complete the carbonization and pyrolysis process, the produced solid products remain at high temperatures. Directly removing the generated solid products pose a fire hazard. Therefore, a lengthy cooling period is required before the produced solid products can be removed safely.

Accordingly, it is necessary to provide a system and method for producing graphite powder to solve the above problems.

### SUMMARY

One objective of the present disclosure is to provide a system for producing graphite powder, and the system allows the objects to enter the microwave heating chamber in an oxygen-free environment. With the utilization of metal plates mounted on a spiral stirring mechanism, the objects can be quickly heated to graphitization temperatures. Further, after the heating process, the produced solid products can be cooled down quickly and removed safely.

Another objective of the present disclosure is to provide a method for producing graphite powder, and the method allows the objects to smoothly enter the microwave heating chamber. With a small amount of arc heating, the objects can be quickly heated to graphitization temperatures. Further, after the heating process, the produced solid products can be cooled down quickly and removed safely.

In order to achieve the above objective, the present disclosure provides a system for producing graphite powder, and the system includes a feeding module, a microwave heating chamber and a discharging module. The feeding module includes a first feeding port, a first valve, a buffer container, a second valve, and a first discharging port and is configured to allow crushed objects to enter the first feeding port, pass through the first valve, and reach the buffer container. The microwave heating chamber has a heating tube disposed therein and is provided with a plurality of microwave power sources configured to provide a microwave power to the heating tube. One end of the heating tube is connected to the second valve. The crushed objects enters the heating tube from the buffer container through the second valve to undergo a heating reaction to decompose into a solid product and a gaseous product. The other end of the heating tube is connected to a third valve. The discharging module includes a cooling device and a solid product discharging port. The solid product enters the cooling device through the third valve for being cooled and then is discharged via the solid product discharging port. The heating tube is provided with a first spiral stirring mechanism configured to push the crushed objects from the one end of the heating tube to the other end of the heating tube. The first spiral stirring mechanism has a first stirring shaft provided with a plurality of first stirring blades.

According to one embodiment of the present disclosure, the first spiral stirring mechanism is made of a ceramic material, and the plurality of first stirring blades are provided with first metal sheets.

According to one embodiment of the present disclosure, the discharging module is further provided with a second spiral stirring mechanism for pushing the crushed objects from one end of the cooling device to the other end of the cooling device. The second spiral stirring mechanism has a second stirring mechanism, and the second spiral stirring mechanism has a second stirring shaft provided with a plurality of second stirring blades.

According to one embodiment of the present disclosure, the heating tube is a quartz tube.

According to one embodiment of the present disclosure, the first valve and the second valve are configured not to be opened at the same time.

According to one embodiment of the present disclosure, the system further includes a control device configured to control activation of the microwave power sources and opening of the first valve, the second valve and the third valve.

According to one embodiment of the present disclosure, the heating tube is further provided with an air outlet hole connected to an air outlet pipeline for discharging the gaseous product to the air outlet pipeline through the air outlet hole.

According to one embodiment of the present disclosure, the air outlet pipeline is further connected to a condensing device and a combustion power generation module. The condensing device is configured to condense a part of the gaseous product into a liquid product, and the combustion power generation module is configured to collect the other part of the gaseous product as a final gaseous product.

In order to achieve the other objective, the present disclosure provides a method for producing graphite powder, and the method includes the following steps: making crushed objects enter a heating tube disposed in a microwave heating chamber through a feeding module, the microwave heating chamber being provided with a plurality of microwave power sources; providing, by the microwave power sources, a microwave power to the heating tube to allow the crushed objects to undergo a heating reaction to decompose into a solid product and a gaseous product; and cooling, by a cooling device provided by a discharging module, the solid product and discharging, by a solid product discharging port, the cooled solid product. The heating tube is provided with a spiral stirring mechanism configured to push the crushed objects from the one end of the heating tube to the other end of the heating tube. The spiral stirring mechanism has a stirring shaft provided with a plurality of stirring blades. The spiral stirring mechanism is made of a ceramic material, and the plurality of stirring blades are provided with metal sheets.

In summary, the system for producing graphite powder according to the present disclosure has the following advantages:
1. The system can be easily manufactured, thus reducing the manufacturing cost.
2. Objects can be rapidly heated in the microwave heating chamber.
3. Objects can smoothly enter and exit the microwave heating chamber.
4. The products decomposed under a high temperature can be safely cooled and collected.

### BRIEF DESCRIPTION OF THE DRAWINGS

In order to make the above and other objectives, features, and advantages of the present disclosure more clearly understood, several preferred embodiments are listed and described below in detail with reference to the accompanying drawings.

FIG. 1 is a schematic diagram of a system for producing graphite powder according to an embodiment of the present disclosure.

FIG. 2A is an exemplary valve according to one embodiment of the present disclosure.

FIG. 2B is a top view of the exemplary valve shown in FIG. 2A.

FIG. 3 is another exemplary valve according to another embodiment of the present disclosure.

FIG. 4 is a flow chart of a method for producing graphite powder according to an embodiment of the present disclosure.

### DETAILED DESCRIPTION

Although the present disclosure may be presented in various embodiments, the embodiments illustrated in the drawings and described herein are preferred embodiments of the present disclosure. Those skilled in the art will understand that the devices and methods specifically described herein and illustrated in the accompanying drawings are considered as examples of the present disclosure rather than limiting illustrative embodiments, and the scope of the present disclosure is defined solely by the claims. The features illustrated or described in an exemplary embodiment may be combined with features of other embodiments. Such modifications and changes are included in the scope of the present disclosure.

Microwaves may cause different effects on objects with different properties and are beneficial for drying and decomposition processes. It is worth noting that some substances may exhibit better absorption at higher temperatures, resulting in a vicious cycle with local temperatures rising sharply to cause over-drying or even carbonization. When the microwave is applied to heat such substances, it is crucial to develop a reasonable heating process to prevent these issues.

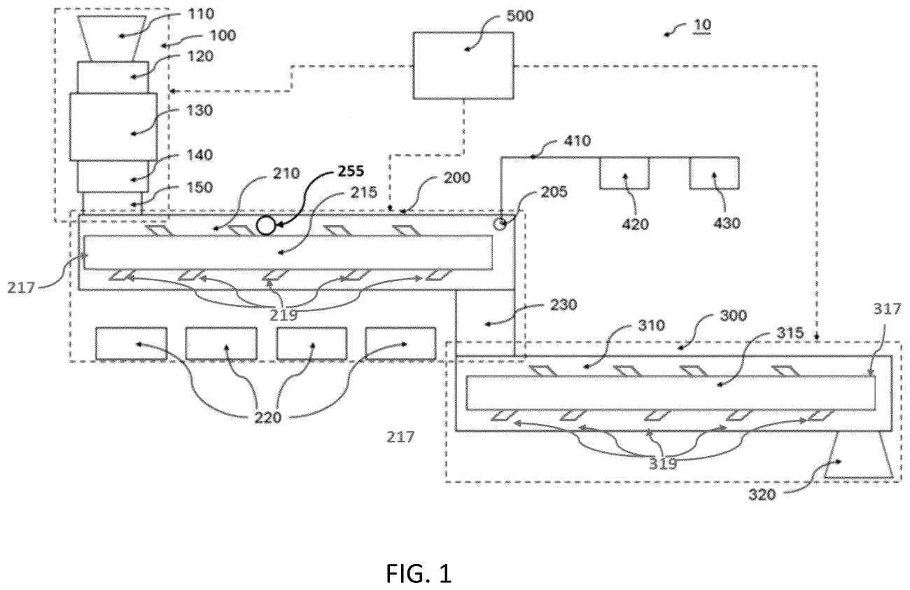

FIG. 1 is a schematic diagram of a system 10 for producing graphite powder according to an embodiment of the present disclosure. Referring to FIG. 1, the system 10 includes a feeding module 100, a microwave heating chamber 200, and a discharging module 300.

The feeding module 100 includes a first feeding port 110, a first valve 120, a buffer container 130, a second valve 140, and a first discharging port 150 and is configured to allow crushed objects to enter the feeding port 110, pass through the first value 120, and reach the buffer container 130.

The crushed objects may be organic wastes or residues that have been crushed. The crushed objects are preferably crushed wood wastes, and the types of the wood wastes include: 1. Manufacturing waste wood: This type of wood wastes is generated by industries such as the wood processing industry, the furniture manufacturing industry, etc. and may include wood boards, wood scraps, wood chips, wood shavings, etc. 2. Construction and demolition waste wood: This type of wood wastes is generated by construction sites or demolition projects and may include wooden piles, wooden frames, wooden floors, etc. 3. Packaging waste wood: This type of wood wastes is generated mainly by logistics and transportation industries and may include packaging materials such as wooden boxes, wooden supports, wooden pallets, etc. ; 4. Agricultural waste wood: This type of wood wastes is generated by agricultural activities and may include tree branches from tree pruning, wooden waste from fruit tree pruning, etc. 5. Commercial waste wood: This type of wood wastes is generated by commercial sites and may include wooden display racks, wood used for store decoration, etc. 6. Urban waste wood: This type of wood wastes is generated in urban areas and may include wood wastes generated by road tree trimming, discarded wooden furniture, etc. In addition, the particle size of the crushed object ranges from 10 mm to 1 mm. The crushing method may include mechanical processes, which may be performed by grinders, crushers, shredders, etc.

The microwave heating chamber 200 has a heating tube 210 disposed therein and is provided with a plurality of microwave power sources 220 configured to provide a microwave power to the heating tube 210. One end of the heating tube 210 is connected to the second valve 140. The crushed objects enter the heating tube 210 from the buffer container 130 through the second valve 140 to undergo a heating reaction between 800 degrees Celsius and 1800 degrees Celsius to decompose into a solid product and a gaseous product. The other end of the heating tube 210 is connected to a third valve 230. The solid product forms carbon material.

The discharging module 300 includes a cooling device 310 and a solid product discharging port 320. The solid product enters the cooling device 310 through the third valve 230 for being cooled and then is discharged via the solid product discharging port 320. The cooling device 310 can utilize cooling water, cooling liquid or cooling gas to surround itself to reduce the temperature of the solid product to be lower than 100 degrees Celsius, thus ensuring the discharging safety.

The heating tube 210 has a first spiral stirring mechanism 215 disposed therein and configured to push the crushed objects from one end of the heating tube 210, which is close to the second valve 140, to the other end of the heating tube 210, which is close to the third valve 230. The first spiral stirring mechanism 215 has a first stirring shaft 217, and the first stirring shaft 217 is provided with a plurality of stirring blades 219. The first spiral stirring mechanism 215 is primarily made of a ceramic material selected, for example, from one of zirconia, alumina, silicon oxide, magnesium oxide and any combination thereof. The stirring blades 219 are provided with metal sheets, which are preferably aluminum sheets or copper sheets. The metal sheets, when exposed to microwave irradiation, generate a micro-arc reaction to increase the heating temperature of the solid product to 1800 degrees Celsius, thus improving the quality, such as crystallinity and conductivity, of the produced carbon material.

The discharging module 300 has a second spiral stirring mechanism 315 disposed therein and configured to push the crushed objects from one end of the cooling device 310, which is close to the third valve 230, to the other end of the cooling device 310, which is close to the solid product discharging port 320. The second spiral stirring mechanism 315 has a second stirring shaft 317 provided with a plurality of stirring blades 319, and the second spiral stirring mechanism 315 is made of a ceramic material or a metal material. Preferably, the second spiral stirring mechanism 315 is made of a metal material.

The heating tube 210 is made of an insulating material that does not absorb microwaves, and the insulating material may be, for example, alumina, zirconia, silica, etc. The heating tube 210 may be a quartz tube.

The first valve 120 and the second valve 140 are configured not to be opened at the same time. That is, when the crushed objects enters the feeding port 110, pass through the opened first valve 120, and then reach the buffer container 130, the second valve 140 is closed. When the first valve 120 is closed and the second valve 140 is opened, the crushed objects in the buffer container 130 can enter the heating tube 210. Therefore, the buffer container 130 is connected to a vacuum pump to reduce the pressure of the buffer container 130 to one-tenth of atmospheric pressure, reducing the oxygen inside the buffer container 130, so that the buffer container 130 remains in a low-oxygen state at all times. As a result, the crushed objects in the buffer container 130 can enter the heating tube 210, thus allowing the heating tube 210 to also remain in a low-oxygen state.

The system 10 further includes a control device 500 configured to control activation of the microwave power sources 220, control opening of the first valve 120, the second valve 140 and the third valve 230, and control rotation of the first spiral stirring mechanism 215 and the second spiral stirring mechanism 315. The first spiral stirring mechanism 215 and the second spiral stirring mechanism 315 are metal stirring mechanisms.

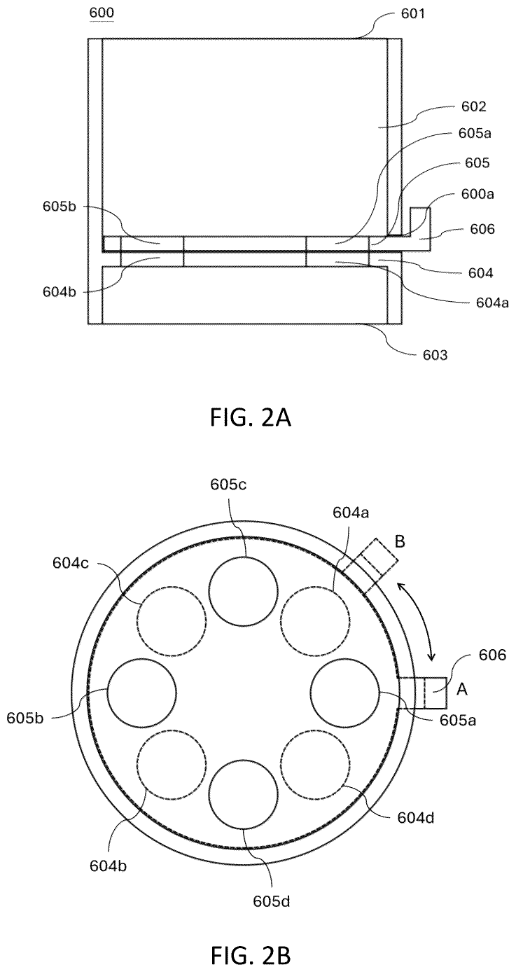

FIG. 2A is an exemplary valve 600 according to one embodiment of the present disclosure. At least one of the first valve 120, the second valve 140 and the third valve 230 may be implemented by the exemplary valve 600. Referring to FIG. 2A. the exemplary valve 600 has a feeding port 601, a feeding space 602, a discharging port 603, a support plate 604, a discharging control plate 605, and a driving connection end 606. The support plate 604 is provided and fixed in the feeding space 602 to support the crushed objects that have entered the feeding space 602. The support plate 604 has four openings 604a, 604b, 604c, and 604d defined thereon. The discharging control plate 605 is movably disposed on the support plate 604 and has four openings 605a, 605b, 605c, and 605d defined thereon. The exemplary valve 600 has an opening 600a defined thereon. The driving connection end 606 passes through the opening 600a and is connected to the discharging control plate 605. The relative positions of the four openings 604a, 604b, 604c, and 604d on the support plate 604 correspond to the relative positions of the four openings 605a, 605b, 605c, and 605d on the discharging control plate 605.

FIG. 2B is a top view of the exemplary valve 600 shown in FIG. 2A. Referring to FIG. 1, FIG. 2A and FIG. 2B, the control device 500 is configured to drive the driving connection end 606 to move between a position A and a position B. When the control device 500 controls to close the exemplary valve 600, the control device 500 drives the driving connection end 606 to be in the position A, thus causing the four openings 604a, 604b, 604c, 604d to interlace with the four openings 605a, 605b, 605c, 605d and allowing the crushed objects to be retained in the feeding space 602. When the control device 500 controls to open the exemplary valve 600, the control device 500 drives the driving connection end 606 to be in the position B, thus causing the four openings 604a, 604b, 604c, 604d to overlap and communicate with the four openings 605a, 605b, 605c, 605d and allowing the crushed objects to pass through the overlapped openings and exit the exemplary valve 600 through the discharging port 603.

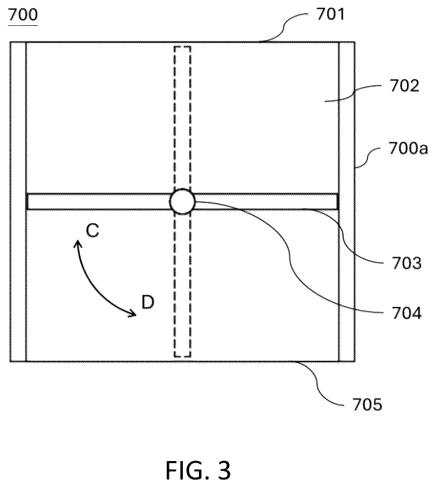

FIG. 3 is another exemplary valve 700 according to another embodiment of the present disclosure. At least one of the first valve 120, the second valve 140 and the third valve 230 may be implemented by the exemplary valve 700. Referring to FIG. 3, the exemplary valve 700 has a feeding port 701, a feeding space 702, a rotating plate 703, a driving rod 704, and a discharging port 705. The feeding port 701 is configured to receive the crushed objects and allow the crushed objects to enter the feeding space 702. At least a part of the rotating plate 703 is fixed to the driving rod 704 and is rotatably disposed in the feeding space 702 via the driving rod 704. The driving rod 704 passes through an opening of the exemplary valve 700 and is exposed outside a housing 700a of the exemplary valve 700.

The control device 500 is configured to drive the driving rod 704 to rotate between a position C and a position D. Referring to FIG. 1 and FIG. 3, the control device 500 is configured to drive the driving rod 704 to rotate for further driving the rotating plate 703 to move between the position C and the position D. When the control device 500 controls to close the exemplary valve 700, the control device 500 drives the driving rod 704 to rotate, so that the rotating plate 703 can stay in the position C to support the crushed objects that have entered the feeding space 702. When the control device 500 controls to open the exemplary valve 700, the control device 500 drives the driving rod 704 to rotate, so that the rotating plate 703 can stay in the position D to allow the crushed objects to pass through the discharging port 703 and exit the exemplary valve 700.

The heating tube 210 is further provided with an air inlet hole 255 configured to allow a gas (e.g., nitrogen) to enter the heating tube 210 through the air inlet hole 255. The heating tube 210 is further provided with an air outlet hole 205 connected to an air outlet pipeline 410 for discharging the gaseous product to the air outlet pipeline 410 through the air outlet hole 205. It should be noted that the gas outlet pipeline 410 is a high-temperature resistant pipeline, particularly a metal pipeline.

The air outlet pipeline 410 is further connected to a condensing device 420 and a combustion power generation module 430. The condensing device 420 is configured to condense a part of the gaseous product into a liquid product, and the combustion power generation module 430 is configured to collect the other part of the gaseous product as a final gaseous product.

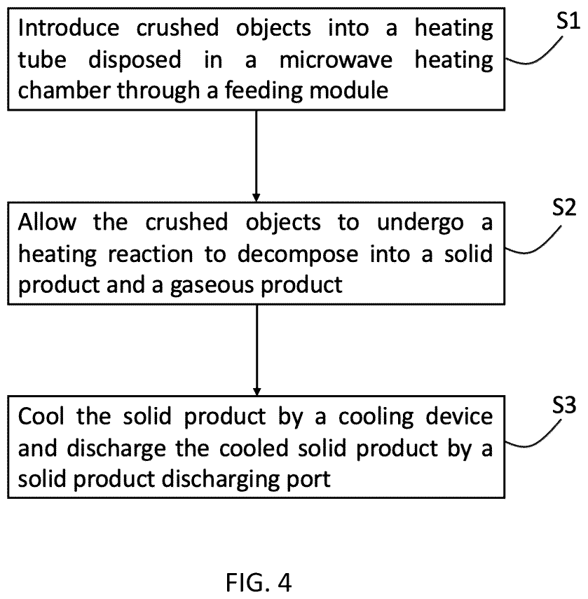

FIG. 4 is a flow chart of a method for producing graphite powder. Referring FIG. 1 and FIG. 4, the method is performed by a system as shown in FIG. 1. The system includes a feeding module, a microwave heating chamber, and a discharging module. The method includes the following steps:
In the step S1, the crushed objects are introduced by the feeding module into a heating tube disposed in the microwave heating chamber, and the microwave heating chamber is provided with a plurality of microwave power sources.
In the step S2, the microwave power sources is provided to provide a microwave power to the heating tube to allow the crushed objects to undergo a heating reaction to decompose into a solid product and a gaseous product.
In the step S3, a cooling device disposed in the discharging module is provided to cool the solid product, and a solid product discharging port disposed in the discharging module is provided to discharge the cooled solid product.

In the method according to one embodiment of the present disclosure, the heating tube is provided with a spiral stirring mechanism configured to push the crushed objects from the one end of the heating tube to the other end of the heating tube, the spiral stirring mechanism has a stirring shaft provided with a plurality of stirring blades, the spiral stirring mechanism is made of a ceramic material, and the plurality of stirring blades are provided with metal sheets.

In summary, the system and method for producing graphite powder according to the present disclosure have the following advantages:
1. The system can be easily manufactured, thus reducing the manufacturing cost.
2. Objects can be rapidly heated in the microwave heating chamber.
3. Objects can smoothly enter and exit the microwave heating chamber.
4. The products decomposed under a high temperature can be safely cooled and collected.

Although the present disclosure has been disclosed in the preferred embodiments described above, these embodiments are not intended to limit the present disclosure. Any person skilled in the art can make various modifications and changes without departing from the spirit and scope of the present disclosure. As described above, various types of modifications and changes can be made without compromising the spirit of the creation. Therefore, the scope of the present disclosure shall be defined by the appended claims.

What is claimed is:

1. A system for producing graphite powder, comprising:
a feeding module including a first feeding port, a first valve, a buffer container, a second valve, and a first discharging port and being configured to allow crushed objects to enter the first feeding port, pass through the first valve, and reach the buffer container;
a microwave heating chamber having a heating tube disposed therein and being provided with a plurality of microwave power sources configured to provide a microwave power to the heating tube, one end of the heating tube being connected to the second valve, the crushed objects entering the heating tube from the buffer container through the second valve to undergo a heating reaction and be decomposed into a solid product and a gaseous product, and the other end of the heating tube being connected to a third valve; and
a discharging module including a cooling device and a solid product discharging port, the solid product entering the cooling device through the third valve for being cooled and then being discharged via the solid product discharging port;
wherein the heating tube is provided with a first spiral stirring mechanism configured to push the crushed objects from the one end of the heating tube to the other end of the heating tube, the first spiral stirring mechanism has a first stirring shaft provided with a plurality of first stirring blades, the first spiral stirring mechanism is made of a ceramic material, and the plurality of first stirring blades are provided with first metal sheets.

2. The system of claim 1, wherein the discharging module is further provided with a second spiral stirring mechanism configured to push crushed objects from one end of the cooling device to the other end of the cooling device, and the second spiral stirring mechanism has a second stirring shaft provided with a plurality of second stirring blades.

3. The system of claim 1, wherein the heating tube is a quartz tube.

4. The system of claim 1, wherein the first valve and the second valve are configured to be not opened at the same time.

5. The system of claim 1, further comprising a control device configured to control activation of the microwave power sources and opening of the first valve, the second valve and the third valve.

6. The system of claim 1, wherein the heating tube is further provided with an air outlet hole connected to an air outlet pipeline for discharging the gaseous product to the air outlet pipeline through the air outlet hole.

7. The system of claim 6, wherein the air outlet pipeline is further connected to a condensing device and a combustion power generation module, the condensing device is configured to condense a part of the gaseous product into a liquid product, and the combustion power generation module is configured to collect the other part of the gaseous product as a final gaseous product.

8. A method for producing graphite powder, the method being performed by a system including a feeding module, a microwave heating chamber, and a discharging module, the method comprising:
introducing, by the feeding module, crushed objects into a heating tube disposed in the microwave heating chamber, the microwave heating chamber being provided with a plurality of microwave power sources;
providing, by the microwave power sources, a microwave power to the heating tube to allow the crushed objects to undergo a heating reaction to decompose into a solid product and a gaseous product; and
cooling, by a cooling device disposed in the discharging module, the solid product and discharging, by a solid product discharging port disposed in the discharging module, the cooled solid product;
wherein the heating tube is provided with a spiral stirring mechanism configured to push the crushed objects from the one end of the heating tube to the other end of the heating tube, the spiral stirring mechanism has a stirring shaft provided with a plurality of stirring blades, the spiral stirring mechanism is made of a ceramic material, and the plurality of stirring blades are provided with metal sheets.

9. The method of claim 8, wherein the metal sheets are aluminum sheets or copper sheets.

10. The method of claim 8, wherein the metal sheets, when exposed to microwave irradiation, increase a heating temperature of the solid product to 1800 degrees Celsius.
